(19) United States
(12) Patent Application Publication
(10) Pub. No.: US 2026/0349822 A1
(43) Pub. Date: Nov. 5, 2026

(54) SERVICE FOR NETWORK INTERFACE CARDS

(71) Applicant: Mellanox Technologies, Ltd., Yokneam Illit (IL)

(72) Inventors: Parav Kanaiyalal Pandit, Bangalore (IN); Ahmad Atamli, Brighton (GB); Gabi Liron, Yokneam Ilit (IL); Noam Katz, Ness Ziona (IL); Shahaf Shuler, Kibbutz Lohamei Hagetaot (IL); Eyal Davidovitz, Kfar Saba (IL); Jason Gunthorpe, Bedford (CA); Yuval Avnery, Hahotrim (IL); Omri Ben David, Bet Alpha (IL); Lijun Yu, Shanghai (CN); Masoud Moshref Javadi, Northville, MI (US); Daniil Provotorov, Tel Aviv (IL)

(21) Appl. No.: 19/136,069

(22) PCT Filed: Mar. 3, 2025
(86) PCT No.: PCT/CN2025/080244

§ 371 Date: Jun. 5, 2025

(30) Foreign Application Priority Data
Mar. 3, 2025 (WO) PCT/CN2025/080244

(51) Int. Cl. G06F 9/50

(52) U.S. Cl. CPC G06F 9/5044; G06F 9/5038; G06F 2209/5013

(57) ABSTRACT

Disclosed are apparatuses, systems, and techniques that allow existing network interface architecture to implement enhanced architecture capabilities. The network interface card may allow modifications to network interface resources in parallel with privileged host controller functionality to implement the enhanced architecture capabilities. A command can be intercepted by a privileged host controller and may be reviewed to validate permissions for the command. After determining the command is directed to modifying a modifiable network interface resource and the source of the command is permitted to modify the network interface resource, the command is provided to the network interface card. Any portion of the command that cannot be completed on the architecture of the network interface card may be executed using the privileged host controller.

### TECHNICAL FIELD

At least one embodiment pertains to processing resources and techniques that are used to improve robustness of network connection applications and devices. For example, at least one embodiment pertains to enhancements for network communication using network interface cards.

### BACKGROUND

A network interface card (NIC) is a hardware component that enables a device, like a computer, server, printer or the like, to connect to a network. The NIC allows the device to send and receive data over the network by facilitating communication between devices. NICs can utilize remote direct memory access (RDMA) to allow data to be transferred directly between the memory of two devices, including remote memory locations, bypassing the host CPU and operating system.

### BRIEF DESCRIPTION OF DRAWINGS

FIG. 1 is a schematic block diagram of an example system architecture providing modification of network interface resources, according to at least one embodiment;

FIG. 2 illustrates an example communication flow between a host device and a network interface card for configuring, and enabling modifications of, a network interface card, according to at least one embodiment;

FIG. 3 illustrates an example communication flow between the host device and the network interface card for executing commands to enhance network interface resources on hardware of the network interface card and a privileged host controller of the host device, according to at least one embodiment;

FIG. 4 is a flow diagram of an example method for enabling enhanced network interface card functionality using limited functionality network interface card hardware, according to at least one embodiment;

FIG. 5 is a flow diagram of an example method for configuring a network interface card to enable modification of network interface resources, according to at least one embodiment;

FIG. 6 is a flow diagram of an example method for modifying a network interface card to enhance network interface resources, according to at least one embodiment; and

FIG. 7 is a block diagram of an example computing device suitable for use in implementing some embodiments of the present disclosure.

### DETAILED DESCRIPTION

Aspects of the present disclosure are directed to providing enhanced network interface resource for network interfacing.

As discussed above, a network interface card (NIC) is a hardware component that enables a device, like a computer, server, printer or the like, to connect to a network. The NIC allows the device to send and receive data over the network by facilitating communication between devices. NICs can utilize remote direct memory access (RDMA) to allow data to be transferred directly between the memory of two devices, including remote memory locations, bypassing the host CPU and operating system.

Traditional implementations of RDMA are limited to executing operations that are supported by the NIC hardware. To enhance RDMA capabilities, a redesign of the hardware is required. Hardware redesigns are costly and time intensive. Further, NICs are traditionally designed with designated central processing units (CPUs) that are limited in size such that they are limited to executing NIC functionality. Any additional NIC functions, such as any functions enabled by enhanced RDMA, may require an increased CPU capacity, which leads to higher design and component costs.

Aspects of the present disclosure address the above and other shortcomings by providing a solution that improves enhanced RDMA for an instance of NIC hardware. More specifically, aspects of the present disclosure utilize a privileged host controller in combination with NIC hardware for enhanced RDMA to allow for increased NIC capabilities. While described as being directed towards using a privileged host controller to enable enhanced RDMA, it should be appreciated that transport objects and network properties of other NIC network interface resources can be enhanced using the present solution.

In at least one embodiment, a NIC can be programmed to be modifiable by a privileged host controller on a host computer (“host”) of a user. In at least one embodiment, upon manufacture of a NIC, the NIC can be programmed using an instruction file stored within a memory of the NIC. The instruction file can be adjusted from traditional instruction files such that, upon implementation, aspects of NIC operations are modifiable by a privileged host controller. The instruction file can be integrated into the NIC during the manufacturing process or by the privileged host controller upon initialization at the host. The instruction file can define what aspects of NIC operations can be altered, validated by users, or the like. For example, a NIC can be configured to allow users to modify transport objects such as queue pairs of RDMA network interface resources. Configuration of the NIC can include limitations on what is modifiable-for example, the user may be allowed to manipulate queue pairs but may be prevented from manipulating memory regions of RDMA. Upon receiving a command from the host, the NIC may first determine if the network interface resource specified in the command corresponds to a modifiable network interface resource, where a network interface resource can represent one or more of transport objects or network properties. Transport objects and network properties can define units of data transported across the network and discrete segments that allow for the transportation of the data. In some embodiments, the transport objects are queue pairs, memory regions, or completion queues. For example, if the NIC is configured to allow queue pairs to be modifiable and memory regions to remain unchanged, a command to modify the memory regions will be disregarded by the NIC.

In at least one embodiment, the NIC may be configured to check the source of the user command. A limited set of users may be permitted to configure the NIC and their user commands may be subject to restrictions. For example, within an organization utilizing a configurable NIC, only system administrators may be permitted to provide user commands.

Further, the system administrators may be limited in the user commands they are authorized to provide based on their level within the administration. Configurations prior to deployment or using a set-up protocol when connecting the NIC to the privileged host controller may allow the user to set up the security protocols for preventing unauthorized user commands.

In at least one embodiment, after the NIC is configured to be modifiable by a privileged host controller, software (e.g., an application or a module that is independent of the privileged host controller) on a host may send to the NIC a NIC modification command to manipulate one or more transport objects and/or network properties. The privileged host controller may intercept the NIC modification command and may first perform a security check and a hardware check. A security check may be used to ensure that the network interface resource requested to be modified is allowed to be modified, the user has the permissions for modifying the network interface resource, the command is a valid command, for example using authentication methods, and the like.

In at least one embodiment, after determining the command is secure, based on NIC capabilities, the NIC may be directed to identify potential changes that are being made at modifiable network interface resources and that can be completed entirely by the NIC or partially by the NIC. For example, upon receiving a command to enhance queue pairs to control congestion, the NIC may determine whether the NIC, using available methods and NIC hardware, can execute the command. The determination can be completed on the NIC after the NIC is provided the secured command from the privileged host controller, or at the privileged host controller that can provide a new command to execute a portion of the original command by the NIC.

In at least one embodiment, upon determining that the NIC can complete the command, the NIC can execute the command and return an acknowledgement to the host that the command has been executed. For example, if the congestion control requested by the NIC modification command can be completed using timed execution of queue pair states that can be controlled by the NIC using the hardware, the NIC can complete the NIC modification command and return an acknowledgement. Upon determining that the NIC can partially complete the command, the NIC can execute a first portion (that NIC is able to execute) of the command and provide a second portion (that NIC is unable to execute) of the command to a CPU on the host. The NIC can return an acknowledgement to the host upon execution of the first portion. The CPU on the host can be used by the privileged host controller to execute the second portion to complete the command. For example, if the congestion control can be partially completed using timed executions of queue pair states in the NIC hardware but needs additional congestion control using traffic throttling not executable by the hardware, the NIC can provide the request for traffic throttling onto the privileged host controller and perform the timed executions. Upon determining that all of the command is to be executed external to the NIC, the command can be provided to the CPU on the host for execution. For example, if the congestion control can only be completed using traffic throttling not executable by the hardware, the NIC can provide the request for traffic throttling onto the privileged host controller.

Embodiments of the present disclosure may improve on the inability of existing technologies to control or modify network interface resources of a NIC without producing new NIC hardware. The user privileged host controller herein described can utilize NIC hardware functionality with software functionality stored on the host to allow programmable enhanced RDMA network interface resources to be used with non-enhanced RDMA NIC firmware. This allows for computational space on the host to be utilized to enable enhanced RDMA configuration without a redesign of NIC components.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medical systems, boating systems, smart area monitoring systems, systems for performing deep learning operations, systems for performing simulation operations, systems for performing digital twin operations, systems implemented using an edge device, systems for generating or presenting at least one of augmented reality content, virtual reality content, mixed reality content, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implementing one or more language models, such as large language models (LLMs), small language models (SLMs), vision language models (VLMs), and multimodal language models (MMLMs) (which may process text, voice, image, and/or other data types to generate outputs in one or more formats), systems implemented at least partially using cloud computing resources, systems for performing generative AI operations, and/or other types of systems.

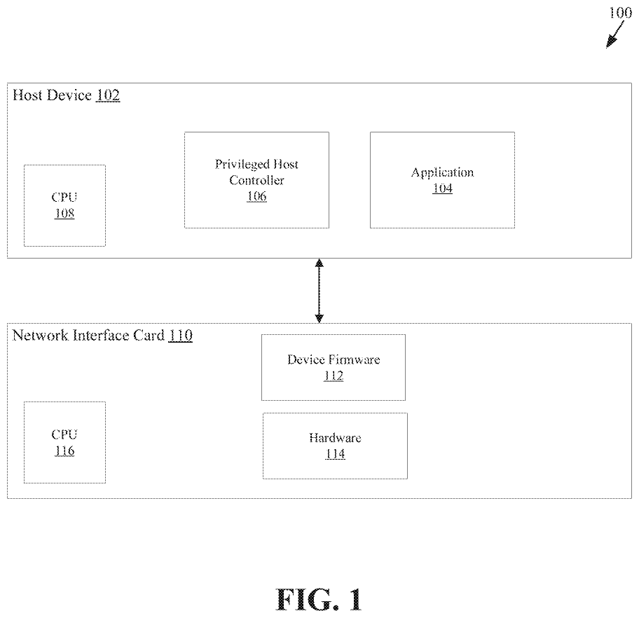

FIG. 1 is a schematic block diagram of an example system architecture 100 providing modification of network interface resources, according to at least one embodiment. The system architecture 100 can include a host device 102 and a network interface card (NIC) 110 for connecting the host device 102 to a network. The host device 102 can include a central processing unit (CPU) 108 manageable by an application (not shown). The host device 102 can further include application(s) 104 and a privileged host controller 106. The application(s) 104 can run in user mode with restricted access to system resources. The privileged host controller 106 can run in privileged mode with access to hardware and system resources and can utilize CPU 108 capabilities for enhancing network capabilities of the NIC 110. The host device 102 can be any device on which a privileged host controller 106 can be hosted and operated. For example, a host device 102 can be a computer, server, printer, etc. which can have a memory or storage for hosting the privileged host controller 106 and a processing unit usable by the privileged host controller 106.

The NIC 110 can include hardware 114 that is responsible for physical and electrical functions to connect the host device 102 to a network. The hardware 114 can handle the physical aspects of network communication, such as data conversion between signal types. The hardware 114 may include components to connect the host device 102 via different network communications. For example, an NIC 110 hardware 114 may be configured to provide connection to a network via ethernet, data link, and the like. The hardware 114 can interface directly with a transmission medium, such as a wire, cable, radio, etc. and can control data flow across the transmission medium. In some embodiments, the hardware 114 can be configured to run a network protocol to enable the communication of data to a network. For example, the hardware 114 can be configured to support an RDMA protocol that allows the hardware 114 to directly access memory regions on remote systems without involving the CPU 116 in the data transfer.

The device firmware 112 may be configured to initialize the NIC 110 upon a boot of the device. Configuring and initializing the NIC 110, for example, by utilizing initialization files stored on the NIC 110 for configuring NIC 110 processes may cause the NIC 110 to be modifiable by the privileged host controller 106 of the host device 102. The initialization files may be provided to the NIC 110, for example, at the end of a manufacturing process, before being put into the system 100. The initialization files may be provided to the NIC 110 by the host device 102 upon connection to the system 100.

The device firmware 112 may further handle data regarding performance of the NIC 110 or capabilities of the NIC 110. In some embodiments, the NIC 110 may be configured to receive NIC modification commands of the application 104 of the host device 102 at the device firmware 112. In some embodiments, such as within an RDMA enabled system, the device firmware 112 can set up NIC interface resources, for example, transport objects and network properties. Transport objects may include Queue Pairs, Completion Queues, Memory Regions, and Protection Domains, and are abstractions that enable high-performance data transfer by managing communication resources, memory access, and operation statuses. These objects help facilitate efficient, direct memory access between systems, allowing for low-latency, high-throughput networking without the involvement of the CPU for each data transfer. Modification of the functioning of the transport objects can adjust the overall network performance of the NIC 110. The CPU 116 can be used to set up protocol operations, such as preparing memory regions, managing connection setups, and dealing with NIC 110 error handling.

In some embodiments, enhanced NIC 110 capabilities may not be supported by the hardware of the NIC 110. For example, the hardware to perform RDMA protocols may be a first set of hardware components. The first set of hardware components may not support enhanced RDMA, instead requiring a second set of hardware components to support enhanced RDMA in traditional systems. For example, enhanced RDMA protocols may require modification of queue pairs, communication queues, and memory regions that are not supported by the hardware 114. To enable enhanced RDMA protocols on the first set of hardware, the RDMA hardware 114, the NIC 110 may require external modifications at the privileged host controller 110.

A device firmware 112 of the NIC 110 can receive messages from and transmit messages to the host device 102 to connect the host device 102 with a network. The device firmware 112 may initialize and configure the NIC upon a boot of the device. Depending on initialization files on the NIC 110, configuring and initializing the NIC 110 may cause the NIC 110 to be modifiable by the privileged host controller 106 of the host device 102. The device firmware 112 may further handle data regarding performance of the NIC 110 or capabilities of the NIC 110. In some embodiments, the NIC 110 may be configured to receive NIC modification commands of the application 104 of the host device 102 at the device firmware 112.

In some embodiments, a CPU 116 of the NIC 110 may be used by the device firmware 112 to complete initialization and data interpretation of the device firmware 112, For example, upon receiving a NIC modification command, the device firmware 112 may provide the NIC modification command to the CPU 116 for processing. Using the CPU 116 of the NIC 110, the device firmware 112 may determine the ability of the NIC 110 hardware 114 to be used to execute the modification. In some embodiments, the CPU 116 is limited in size to only compute enough data to maintain the intended functionality of the hardware 114 of the NIC 110. Any additional processing required to execute a NIC modification command may require more computational capabilities than are within the NIC 110. For example, if a NIC modification command is directed towards an enhanced RDMA modification, the NIC 110 hardware 114 may be able to execute a first portion of the command, but any additional modifications that are not performed on the hardware 114 may not be supported by available CPU 116 capabilities.

In some embodiments, the application 104 can output commands to perform networking and system tasks throughout the system 100. For example, an output command can be a NIC modification command. NIC modification commands can be commands issued to optimize, monitor, and manage system resources of applications, devices, and services connected to the host device 102. For example, NIC modification commands can be issued to the CPU 108, a memory, a storage, and the NIC 110 to allocate resources, monitor performance, manage priority, limit resources, balance system loads, etc. NIC modification commands output by the application 104 can be generated by the system automatically based on current workload conditions or can be user generated by a system administrator or host device 102 user with administrative privileges to configure, manage, and monitor resources.

In some embodiments, the host device 102 can include a privileged host controller 106 coupled to the application 104 and the CPU 108. The privileged host controller 106 may be utilized to enhance capabilities of the NIC 110. To enhance the capabilities of the NIC 110, the privileged host controller 106, may monitor the application 104 to identify any outgoing commands. The privileged host controller 106 may be able to review an identified outgoing command and determine if the command is a NIC modification command. The privileged host controller 106 may access communication channels between the application 104 and the NIC 110, such that a command going between the application 104 and the NIC 110 can be intercepted by the privileged host controller 106 and prevented from reaching the NIC 110.

In some embodiments, the privileged host controller 106 may be configured to verify the NIC modification command is a secure command. A secure command may be a NIC modification command that has been generated by an authorized user of the host device 102. A secure command may be NIC modification command that is directed to modifying one or more network resources that are authorized to be modified. A secure command may be a NIC modification command that is directed to modifying one or more network resources that are authorized to be modified by the user of the host device 102.

In some embodiments, the privileged host controller 106 may be configured to verify whether the NIC modification command of the application 104 is executable by the NIC 110 on the NIC 110 hardware 114. In some embodiments, the privileged host controller 106 may determine that the NIC modification command of the application 104 is partially executable by the NIC 110 hardware 114. In some embodiments, the privileged host controller 106 may determine that the NIC modification command of the application 104, is not executable by the NIC 110 hardware 114. In embodiments in which the command is partially executable by the NIC 110 hardware 114 or not executable by the NIC 110 hardware 114, the privileged host controller 106 may be configured to execute a portion of the NIC modification command as to fulfil the NIC modification command as intended by the user of the application 104. For example, the NIC modification command may direct the NIC 110 control congestion at a certain level of control. The NIC 110 hardware 114 may be usable to time executions of queue pair states to control congestion. However, based on the level of control specified by the NIC modification command, additional congestion control measures may be required. If no other measures can be taken on the hardware 114 without modifying the physical components of the hardware 114, for example through redesign of the hardware 114, the privileged host controller 106 may determine actions that can be taken on the privileged host controller 106. If additional congestion control measures are required, the congestion control level required by the NIC modification command may be completed by traffic throttling measures taken at the privileged host controller 106.

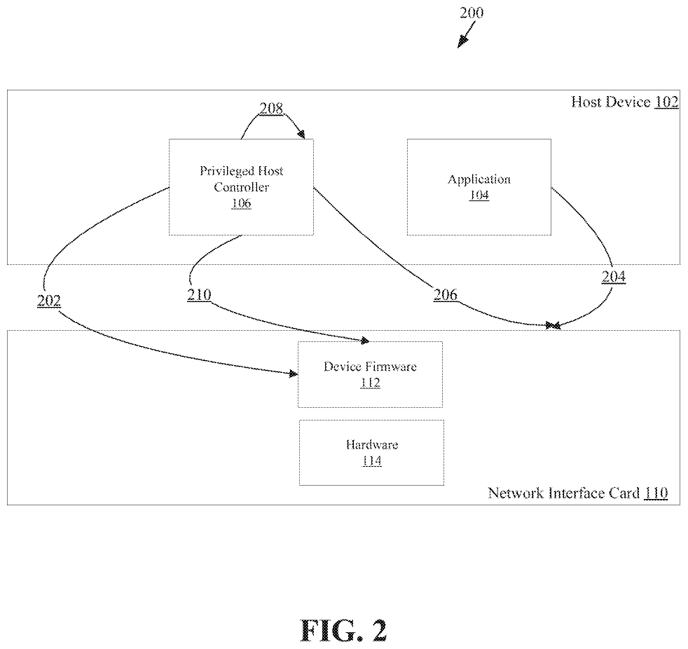

FIG. 2 illustrates an example communication flow 200 between the host device 102 and. the NIC 110 for configuring, and enabling modifications of, the NIC 110, according to at least one embodiment. The NIC 110 may first be coupled with the host device 102 to become part of the system 100. Coupling may include connecting via physical connection or wireless connection. Over the established connection, the privileged host controller 106 of the host device 102 may provide instructions 202 to the device firmware 112 of the NIC 110. The instructions 202, in some embodiments, can be included in an instruction file to be stored on the NIC 110. An instruction file can be a configuration or firmware file that provides the necessary instructions for operation of the NIC 110. The instruction file can include firmware instructions for directing data transmission and reception, configuration settings, and boot instructions. The instruction file can include a list of allowed network interface resources of the NIC that are modifiable by the privileged host controller 106. For example, boot instructions may not be modifiable, however, instructions may identify one or more network interface resources for directing data transmission and reception that may be modifiable via commands.

In some embodiments, rather than the instruction file being provided to the NIC 110 by the host device 102, the instruction file can be loaded onto the NIC 110 during the manufacturing process, or prior to delivery of the NIC 110 to the user and the host device 102. In some embodiments, the instructions 202 can be communication instructions between the host device 102 and the NIC 110 to determine the modifiable network interface resources as defined in the instruction file. The instructions 202 may allow the privileged host controller 106 to generate a permissions list for use in determining allowability of commands. The instructions 202 may allow the privileged host controller 106 to identify configurations of the NIC 110 to enable the privileged host controller 106 to aid the NIC 110 in executing commands for enhanced RDMA NIC 110 functionalities. For example, the instructions 202 may include a description of CPU capacities of the NIC 110 which may enable the privileged host controller 106 to identify processing capabilities of the NIC 110. Using the identified processing capabilities, the privileged host controller 106 may be able to compensate for commands that require CPU capacities that exceed the identified CPU capacities.

In some embodiments, when transmitting and receiving instructions 202, the host device 102 may establish a connection between the privileged host controller 106 and the device firmware 112 that can be utilized for communications during the execution of commands that are directed to enhanced RDMA functionalities on RDMA hardware 114 of the NIC 110. The communication may be a two-way communication allowing the privileged host controller 106 to provide commands to the device firmware 112 and the NIC 110 to provide messages to the privileged host controller 106. Messages may include flags indicating a completion of execution, indication of failure to execute a command, and/or the like.

After the instructions 202 have enabled the connection and facilitated the information transfer between the NIC 110 and the privileged host controller 106, the host device 102 may provide a command 204 to the NIC 110. As described above, the command may be an automatic command generated by the application 104 or a user command generated by a user of the host device 102. The command may be issued by the application 104 and may include one or more pieces of information regarding the command. For example, information regarding the command can include metadata collected during creation of the command. The metadata may include identification of the user, a time of creation, and the like. Further, the command may include direction to modify one or more network interface resources of the NIC 110. The metadata may be used to determine if a command is a valid command using security metrics.

Directions to modify one or more network interface resources may include an identification of a specific network interface resource and a result for the specific network interface resource. For example, the command may include an identification of one or more queue pairs to modify in order to implement congestion control and provide instructions on specific timed execution adjustments of the queue pairs. In some embodiments, the command can include time intervals at which to execute the queue pairs or can include a desired congestion control result and leave the exact time intervals for determination by the NIC 110. In some embodiments, the command may only include directions to modify network interface resources to control congestion but may not specify which network interface resources are to be modified or the modifications to occur to enable the congestion control.

In some embodiments, the privileged host controller 106 will intercept 206 the command prior to the command being received at the NIC 220. In order to intercept the command, the privileged list controller 106 may monitor all command outputs of the application 104 and may identify commands that are intended for the NIC 110. In some embodiments, the privileged host controller 106 may monitor one or more communication lines from the application that are known to connect with the NIC 110. The privileged host controller 106 may intercept 206 all commands along those lines and review them for their intended destination or may review command packages for intended destination and intercept 206 the relevant commands. In some embodiments, the interception can be completed by the device firmware 112. Rather than intercepting the command on the way to the NIC 110, the command may arrive at the NIC 110 and may be transferred to the privileged host controller 106 without any actions to execute the command.

In some embodiments, the privileged host controller 106 may review the intercepted command 208 to determine the validity of the command. In some embodiments, a validity determination can include a security check that determines whether the modification is from an authorized user. For example, one or more administrative employees may have access to the host device and may be permitted to operate user devices. However, each authorized user may have different permissions that may limit which network interface resources they can request to be modified, or the types of modifications they can make. The privileged host controller 106 may identify a user using, for example a user ID associated with a login of the user of the host device 102, and information regarding the intended modification and/or the network interface resources identified in the command. The privileged host controller 106 may compare the details in the command to the instructions 202 to determine if the network interface resources identified in the command are modifiable according to the NIC 110 instruction file and if the network interface resources are modifiable by the user associated with the user ID.

As described above, in some embodiments, the privileged host controller 106 may receive a command of the application 104 that identifies enhanced NIC 110 capability, for example an enhanced RDMA capability, to achieve rather than an individual network interface resource to be modified. The privileged host controller 106 may generate specific commands that may affect modifications of network interface resources to accomplish the enhanced RDMA capability. Using the generated commands and the associated network interface resources, the privileged host controller 106 may determine whether the command of the application 104 is a valid command. For example, a user may provide a command to the application 104 to control congestion of the NIC 110. After intercepting the command, the privileged host controller 106 can identify the user that issued the command and determine that controlling congestion would include modification of the timed execution of queue pairs. The privileged host controller 106 can then determine whether the queue pairs of the NIC 110 can be modified, and if the user has the permissions to modify the queue pairs.

In some embodiments, checking the validity of the command 208 can include generating a command or one or more sub-commands that are actionable by the network interface card 110. As described above, a command may indicate an objective rather than identify a network interface resource and the modification for the network interface resource. The privileged host controller 106 may identify the network interface resource to be modified by the NIC 110 and a modification for the network interface resource and to generate a command. In some embodiments, based on the limitations of the hardware 114, the enhanced capabilities may not be achievable using modifications of the hardware 114 alone. The privileged host controller 106 may determine actionable sub-commands that include modifications for the NIC 110, to provide to the NIC 110. For example, if the command issued by the application 104 requires a level of congestion control of the NIC 110, the privileged host controller 106 may determine that the level of congestion control is not achievable by the hardware 114 alone. The privileged host controller 106 may then generate a sub-command to direct modifications that can be implemented at the NIC 110 to partially achieve the level of congestion control directed by the command. The privileged host controller 106 may similarly generate actions to be taken by the privileged host controller 106 to satisfy the level of congestion control of the command. For example, the privileged host controller 106 may identify traffic throttling measures that can be taken by the host device 102 to supplement the modifications of the queue pairs to attain the desired congestion control.

After checking the validity 208 of the privileged host controller 106 and/or generating a command or sub-command actionable by the NIC 110, the privileged host controller 106 may provide the command 210 to the device firmware 112 for execution.

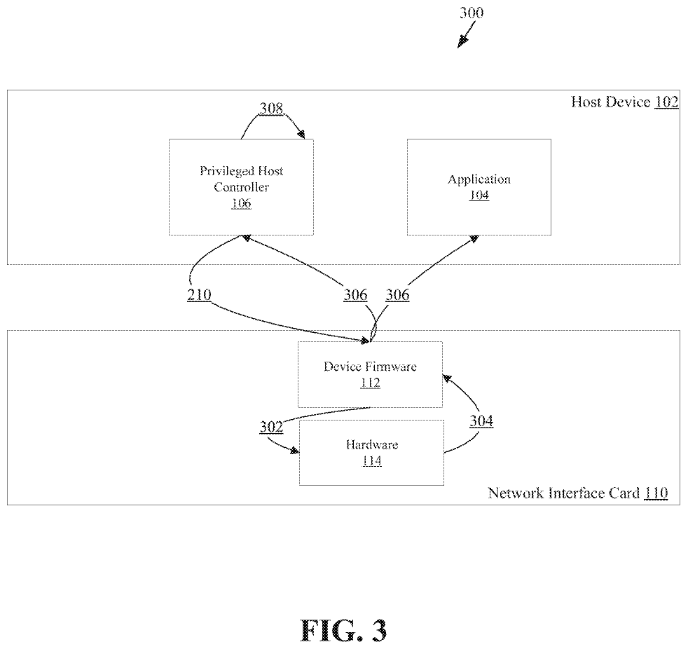

FIG. 3 illustrates an example communication flow 300 between the host device 102 and the network interface card 110 for executing commands to modify network interface resources on hardware 114 of the network interface card 110 and a privileged host controller 106 of the host device 102, according to at least one embodiment. As described above, the privileged host controller 106 may provide the command originally intercepted 206, a generated command, or a sub-command to the NIC 110. Based on the command received, the device firmware 112 may instruct 302 the hardware 114 to implement the modifications. The hardware 114 can implement modifications by adjusting how registers within the hardware 114 transmit and receive packets of information. For example, when modifying time intervals of queue pair execution to control congestion, the hardware 114 may adjust the number of entries a queue can hold, such as increasing queue depth to limit transmission from the NIC 110, adjust the timeouts to limit the maximum amount of time a packet can stay in the queue before processing or discard, and adjusting interrupt schedules to adjust the timing of interrupts, and the like.

In some embodiments, the device firmware 112 may review the command and determine whether the command can be executed. In some embodiments, multiple commands concerning different NIC 110 functionalities may be modified using commands from the host device 102. A first command may require modification of a network interface resource to a first configuration, and a second command may require modification of the network interface resource to a second configuration. Adjusting the network interface resource may impede functionality of the NIC 110 for operating according to the first command. The adjustment may cause incongruent operations of the NIC 110 hardware, loss of functionality created by the first command, or the like. Therefore, the NIC 110 may determine not to complete a modification according to the second command, instead returning a notification of a failure to modify. For example, a first command may cause modification of one or more network interface resources to lower the latency of the NIC 110 network communications. This may require faster interrupts, shorter timeouts, and the like. The second command may be directed to modify one or more network interface resources to control congestion. Controlling congestion may require modifying the previously modified network interface resources such that the latency will increase. Additionally, not all network interface resources modified by the first command may be modified by the second command. The modified resources not modified by the second command may cause other issues when operating the NIC 110. The device firmware 112 may then decide not to direct the hardware 114 to modify the network interface resources according to the command.

In some embodiments, the hardware 114 can send a notification 304 back to the device firmware 112. The notification can indicate an acknowledgement of the command and successful modification, or notification of a failure to modify the hardware 114 according to the command. Failure to modify the hardware 114 may be the result of a lack of resources, conflicting commands, and the like. For example, to implement a level of congestion control directed by the command, the hardware 114 may determine the queue depth has already been extended as far as memory resources allow. Without the ability to expand the queue to aid in congestion control, the hardware 114 may be unable to modify the hardware 114 to meet the requirements of the command and may send back a notification of failure.

Following completion of the modification, the device firmware 112 may notify the host device 102 of the execution of the modification 306. In some embodiments, the command can be executed completely by modifications made on the NIC 110. After execution of the command on the NIC 110, the device firmware 112 may send a notification, such as an acknowledgement to the application 104 that the execution is complete.

In some embodiments, a portion of the command is executed on the privileged host controller 106. The device firmware 112 may provide a notification of the execution of the command to the privileged host controller 106. After notification of the completion of the modification at the NIC 110, or parallel to the operations on the NIC 110 302-306, the privileged host controller 106 may execute one or more modifications to the network interface resources that are unimplementable on the NIC 110 or require additional computational power than that of which is on the NIC 110. As described above, the privileged host controller 106 may determine a sub-command for the NIC 110 to implement a portion of a command of the application 104. The privileged host controller 106 may determine one or more additional sub-commands to fulfil the command that are to be executed at the privileged host controller 106. The one or more sub-commands for the privileged host controller 106 may be generated based on an inability of the NIC 110 to execute that sub-command. For example, in some embodiments, modifications to enable enhanced RDMA functionalities may require CPU resources that exceed the CPU resources on the NIC 110. The privileged host controller 106 may execute actions using the large CPU on the host device 102. The privileged host controller 106 may execute the remaining portion of the command 308.

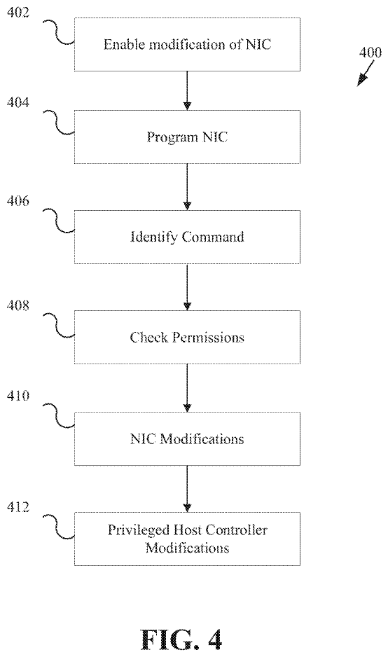

FIG. 4 is a flow diagram of an example method 400 for enabling enhanced network interface card 110 functionality using limited functionality network interface card hardware, according to at least one embodiment. The method begins at block 402 with the enablement of the modification of the NIC 110 using either the privileged host controller 106 or during a manufacturing process. As described above, NIC 110 hardware 114 may be hardware 114 that is designed for limited functionality. To support enhanced functionality of the NIC 110, for example enhanced RDMA functionality, the hardware 114 may be redesigned. Alternatively, or in addition to a hardware 114 redesign, enhanced functionality may be possible through the enablement of modifications of network interface resources of the NIC 110. Network interface resources can be communication instances that are utilized for managing the transmission and reception of data for network communication protocols. For example, RDMA protocols may use queue pairs and the like to enable bidirectional communication between two devices over a network. Modifications of NIC 110 network interface resources can allow for increased functionality on limited hardware. The modifications allowed may be limited to specific network interface resources, for example network interface resources usable and enhanced RDMA protocols. The modification enablement may occur using an instruction file stored on the NIC 110 that controls NIC 110 operation.

At block 404, the NIC 110 can be programmed by a privileged host controller 106 of a host device 102. Programming the NIC 110 can include enabling a connection between the host controller 106 and the NIC 110 and identifying the capabilities and hardware 114 functionality of the NIC 110 to determine the limitations of the NIC 110. Further, programming can include the privileged host controller 106 identifying the network interface resources that are modifiable as defined in the instruction file.

At block 406, the privileged host controller 106 can identify a command issued at the application 104 and intercept the command for security validation. Identifying the command can include monitoring command outputs, or all outputs, of the application 104 to identify a command directed to the NIC 110. The privileged host controller 106 main monitor communication lines known to carry commands or other instructions to the NIC 110 or may monitor generation points for commands and intercept commands before they are transmitted. In some embodiments, commands can be identified by review of the intended recipient, review of the particulars of the command, and the like.

A block 408, the privileged host controller can check the permissions identified in block 404 to determine if the network interface resources to be modified within the command are modifiable and if the user that generated the command has permissions to modify the network interface resource. The permission check may constitute additional security protocol checks including identifying the origin of the command and completing handshake protocols to ensure the security of the command.

At block 410, the NIC 110 can implement the modifications from the commands. In some embodiments, the command can be executed using only the hardware 114. In some embodiments, a portion of the command may be executed by modifications at the hardware 114. Following the executions of the portion of the command and/or in parallel to the execution of the portion of the command at the hardware, 114, a portion of the command may be executed at the privileged host controller at block 412.

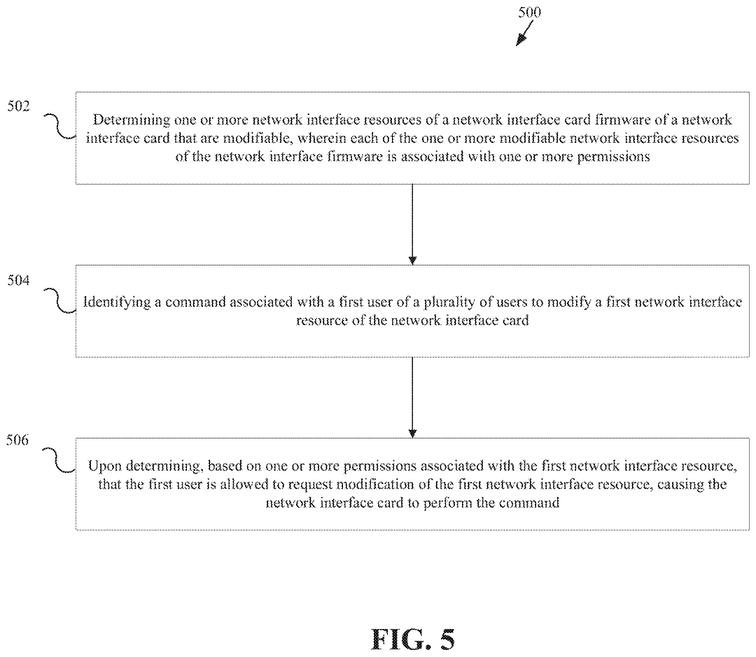

FIG. 5 is a flow diagram of an example method 500 for configuring a network interface card 110 to enable modification of network interface resources, according to at least one embodiment. The method 500 begins at block 502, wherein the privileged host controller 106 determines one or more network interface resources of NIC 110 hardware 114 that are modifiable. In some embodiments, the one or more modifiable network interface resources can be identified by accessing an instruction file stored within a memory storage on the network interface card to identify the one or more network interface resources that are modifiable. In some embodiments, each of the one or more modifiable network interface resources is associated with one or more permissions. In some embodiments, a permission identifies a subset of the one or more network interface resources modifiable by a user of the plurality of users or by an automated command generated at the host device 102. The permissions may indicate each modifiable network interface resource as indicated in the instruction file. Each modifiable network interface resource may be associated with a list of users that can modify the network interface resource.

The method 500 continues at block 504. The privileged host controller 106 identifies a command associated with a first user of a plurality of users to modify a first network interface resource of the NIC 110. In some embodiments, one or more users may be able to generate commands for the NIC 110 that are intercepted by the privileged host controller 106. Each user may have a different credential to log into the host device 102 to generate the command. Based on the credentials, the privileged host controller 106 may determine which user is generating the command. In some embodiments, multiple user devices may connect with the host device 102 to generate commands. Each user device may include an identifier for the user associated with the user device. For example, within a company, each administrator of the network may be issued a laptop that may connect with the host device 102 to monitor and/or adjust functionality of the NIC 110. Using the identification of the user device used during the generation of the command, the privileged host controller 106 can identify a user.

The method 500 continues at block 506. The privileged host controller 106 may, upon determining, based on one or more permissions associated with the first network interface resource, that the first user is allowed to request modification of the first network interface resource, cause the network interface card to perform the command. The permissions maintained at the privileged host controller 106 may indicate each user and the associated network interface resources modifiable by the user. Determining that the first user is allowed to request a modification may include determining that the first network interface resource is part of the one or more modifiable network interface resources identified based on the instruction file. Determining that the first user is allowed to request a modification may include confirming that the user issuing the command is allowed to modify said network interface resource.

After the privileged host controller 106 determines the command is valid, the privileged host controller 106 may cause the NIC 110 to perform the command. Performing the command may include forwarding the command to the NIC 110, receiving a notification of the network interface card indicating that execution of at least a portion of the command to modify the first network interface resource has not been completed, and executing, using the privileged host controller, an incomplete portion of the command to modify the first network interface resource.

In some embodiments, the NIC 110, for example at the hardware 114, can be configured (e.g., modified) to allow for enhanced NIC 110 functionalities. However, in some embodiments, modifications on the NIC 110 alone may not be enough. In such circumstances, the NIC 110, after executing a portion of the command executable by the NIC 110, may indicate to the privileged host controller 106 a portion of the command that has not be executed. The privileged host controller 106 may complete execution of the command on the host device 102.

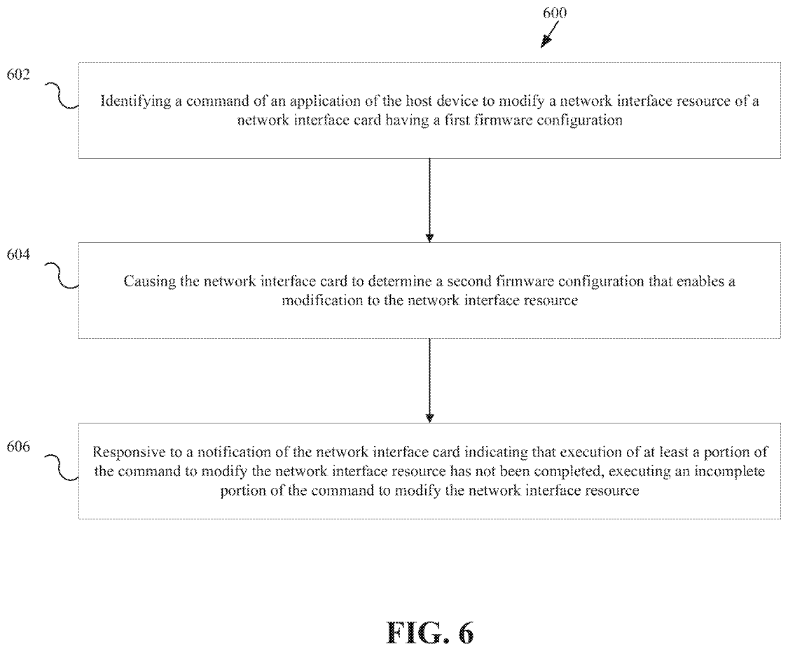

FIG. 6 is a flow diagram of an example method 600 for modifying a NIC 110 to enhance network interface resources, according to at least one embodiment. The method may begin at block 602. The privileged host controller 106 of the host device 102 may identify a command of an application of the host device to modify a network interface resource of the NIC 110 having a first hardware configuration. In some embodiments, the one or more network interface resources comprise one or more of transport objects or network properties. In some embodiments, the transport objects are queue pairs, memory regions, or completion queues. The first hardware configuration may include arrangements of transport objects or network properties within registers. For example, a first hardware configuration may include queue pairs with an established queue depth, interrupt time, and the like. Identifying a command using the privileged host controller 106 may include monitoring the application 104 and intercepting the command.

At block 604, the privileged host controller 106 may cause the NIC 110 to determine a second hardware configuration that enables a modification to the network interface resource. The command may include an objective of modification, a network interface resource and a target operating metric, and/or a network interface resource and a new configuration for the network interface resource. An objective of a modification may include an enhanced functionality not natively provided for by the hardware 114. For example, an objective of modification may be a desire to decrease latency of the data transmissions. To determine a second hardware configuration to meet the objective, the privileged host controller 106 may identify the network interface resources that would need to be modified, and a modification to be made. For example, to decrease latency, the privileged host controller 106 may identify that queue pairs need to be modified, and that decreasing the timeouts between transmissions will achieve the result.

In some embodiments, the command may identify a network interface resource to modify and a target operating metric. More than one modification could be made on various network interface resources to achieve a similar result. Based on other objectives, a user may want to modify one network interface resource over another. The command may include the identification of the network interface resource and direct a modification to achieve an objective. For example, the command may indicate the network interface resource to be modified as a communication region and the objective to decrease latency. Rather than modify queue pairs to achieve a similar result, the command may allow for a reallotment of communication regions to lower latency.

In some embodiments, the command may include an indication of a specific network interface resource and an exact modification to be made. For example, the command may indicate a modification to be made to the communication regions and may provide exact reformatting measures to determine the new size of the communication regions.

In some embodiments, identifying a command can further include determining, using the privileged host controller 106, an executable portion of the command to modify the network interface resource and providing the executable portion of the command to the network interface card for execution. As described above, the limited capabilities of the NIC 110 may be subsidized by operations performed by the privileged host controller 106 using the CPU 108 of the host device 102. When receiving a command, the privileged host controller 106 may identify a portion of the command that can be executed using the NIC 110. The portion of the command may be used to generate a new command to be provided to the NIC 110 for execution.

At block 606, responsive to a notification of the NIC 110 indicating that execution of at least a portion of the command to modify the network interface resource has not been completed, the privileged host controller 106 executes, using the privileged host controller 106, an incomplete portion of the command to modify the network interface resource. As described above, the privileged host controller 106 may be utilized to enhance NIC 110 capabilities by utilizing the CPU 108 of the host device 102.

In some embodiments, the privileged host controller 106 can further identify a second command of the application of the host device to modify a second network interface resource of the network interface. Upon determining that the second network interface resource is not modifiable according to the second command, a third command is generated to modify a third network interface resource as an alternative to the second network interface resource. As described above, multiple network interface resources may be utilized to achieve a same or similar outcomes. In some embodiments, a command may be intercepted by the privileged host controller 106 that directs the NIC 110 to modify a network interface resource that is not modifiable by that user and/or any user. Rather than merely return a notification of the inability to execute the command, the privileged host controller 106 may generate a new command that may achieve a similar objective by modifying a modifiable network interface resource. For example, a command may be directed to modifying communication regions to decrease latency. Upon determining that the communication regions are not modifiable, the privileged host controller 106 may generate a command to provide to the NIC 110 to adjust the queue pairs to decrease latency instead.

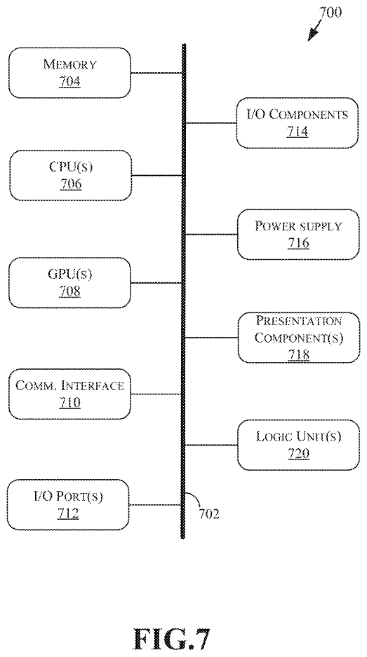

FIG. 7 is a block diagram of an example computing device(s) 700 suitable for use in implementing some embodiments of the present disclosure. Computing device 700 may include an interconnect system 702 that directly or indirectly couples the following devices: memory 704, one or more central processing units (CPUs) 706, one or more graphics processing units (GPUs) 708, a communication interface 710, input/output (I/O) ports 712, input/output components 714, a power supply 716, one or more presentation components 718 (e.g., display(s)), and one or more logic units 720. In at least one embodiment, the computing device(s) 700 may comprise one or more virtual machines (VMs), and/or any of the components thereof may comprise virtual components (e.g., virtual hardware components). For non-limiting examples, one or more of the GPUs 708 may comprise one or more vGPUs, one or more of the CPUs 706 may comprise one or more vCPUs, and/or one or more of the logic units 720 may comprise one or more virtual logic units. As such, a computing device(s) 700 may include discrete components (e.g., a full GPU dedicated to the computing device 700), virtual components (e.g., a portion of a GPU dedicated to the computing device 700), or a combination thereof.

Although the various blocks of FIG. 7 are shown as connected via the interconnect system 702 with lines, this is not intended to be limiting and is for clarity only. For example, in some embodiments, a presentation component 718, such as a display device, may be considered an I/O component 714 (e.g., if the display is a touch screen). As another example, the CPUs 706 and/or GPUs 708 may include memory (e.g., the memory 704 may be representative of a storage device in addition to the memory of the GPUs 708, the CPUs 706, and/or other components). As such, the computing device of FIG. 7 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 7.

The interconnect system 702 may represent one or more links or busses, such as an address bus, a data bus, a control bus, or a combination thereof. The interconnect system 702 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 706 may be directly connected to the memory 704. Further, the CPU 706 may be directly connected to the GPU 708. Where there is direct, or point-to-point connection between components, the interconnect system 702 may include a PCIe link to carry out the connection. In these examples, a PCI bus need not be included in the computing device 700.

The memory 704 may include any of a variety of computer-readable media. The computer-readable media may be any available media that may be accessed by the computing device 700. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 704 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 700. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 706 may be configured to execute at least some of the computer-readable instructions to control one or more components of the computing device 700 to perform one or more of the methods and/or processes described herein. The CPU(s) 706 may each include one or more cores (e.g., one, two, four, eight, twenty-eight, seventy-two, etc.) that are capable of handling a multitude of software threads simultaneously. The CPU(s) 706 may include any type of processor, and may include different types of processors depending on the type of computing device 700 implemented (e.g., processors with fewer cores for mobile devices and processors with more cores for servers). For example, depending on the type of computing device 700, the processor may be an Advanced RISC Machines (ARM) processor implemented using Reduced Instruction Set Computing (RISC) or an x86 processor implemented using Complex Instruction Set Computing (CISC). The computing device 700 may include one or more CPUs 706 in addition to one or more microprocessors or supplementary co-processors, such as math co-processors.

In addition to or alternatively from the CPU(s) 706, the GPU(s) 708 may be configured to execute at least some of the computer-readable instructions to control one or more components of the computing device 700 to perform one or more of the methods and/or processes described herein. One or more of the GPU(s) 708 may be an integrated GPU (e.g., with one or more of the CPU(s) 706 and/or one or more of the GPU(s) 708 may be a discrete GPU. In embodiments, one or more of the GPU(s) 708 may be a coprocessor of one or more of the CPU(s) 706. The GPU(s) 708 may be used by the computing device 700 to render graphics (e.g., 3D graphics) or perform general purpose computations. For example, the GPU(s) 708 may be used for General-Purpose computing on GPUs (GPGPU). The GPU(s) 708 may include hundreds or thousands of cores that are capable of handling hundreds or thousands of software threads simultaneously. The GPU(s) 708 may generate pixel data for output images in response to rendering commands (e.g., rendering commands from the CPU(s) 706 received via a host interface). The GPU(s) 708 may include graphics memory, such as display memory, for storing pixel data or any other suitable data, such as GPGPU data. The display memory may be included as part of the memory 704. The GPU(s) 708 may include two or more GPUs operating in parallel (e.g., via a link). The link may directly connect the GPUs (e.g., using a communication interface such as NVIDIA®) NVLink®) or may connect the GPUs through a switch (e.g., using a communication interface switch such as NVIDIA® NVSwitch®). When combined together, each GPU 708 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 706 and/or the GPU(s) 708, the logic unit(s) 720 may be configured to execute at least some of the computer-readable instructions to control one or more components of the computing device 700 to perform one or more of the methods and/or processes described herein. In embodiments, the CPU(s) 706, the GPU(s) 708, and/or the logic unit(s) 720 may discretely or jointly perform any combination of the methods, processes and/or portions thereof. One or more of the logic units 720 may be part of and/or integrated in one or more of the CPU(s) 706 and/or the GPU(s) 708 and/or one or more of the logic units 720 may be discrete components or otherwise external to the CPU(s) 706 and/or the GPU(s) 708. In embodiments, one or more of the logic units 720 may be a coprocessor of one or more of the CPU(s) 706 and/or one or more of the GPU(s) 708.

Examples of the logic unit(s) 720 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)-which may include one or more direct memory access (DMA) systems, one or more vision or vector processing units (VPUs), one or more pixel processing engines (PPEs), one or more decoupled accelerators (e.g., decoupled lookup table (DLUT) accelerators), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 710 may include one or more receivers, transmitters, and/or transceivers that allow the computing device 700 to communicate with other computing devices via an electronic communication network, included wired and/or wireless communications. The communication interface 710 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 720 and/or communication interface 710 may include one or more data processing units (DPUs) to transmit data received over a network and/or through interconnect system 702 directly to (e.g., a memory of) one or more GPU(s) 708.

The I/O ports 712 may allow the computing device 700 to be logically coupled to other devices including the I/O components 714, the presentation component(s) 718, and/or other components, some of which may be built in to (e.g., integrated in) the computing device 700. Illustrative I/O components 714 include a microphone, mouse, keyboard, joystick, game pad, game controller, satellite dish, scanner, printer, wireless device, etc. The I/O components 714 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 700. The computing device 700 may be include depth cameras, such as stereoscopic camera systems, infrared camera systems, RGB camera systems, touchscreen technology, and combinations of these, for gesture detection and recognition. Additionally, the computing device 700 may include accelerometers or gyroscopes (e.g., as part of an inertia measurement unit (IMU)) that allow detection of motion. In some examples, the output of the accelerometers or gyroscopes may be used by the computing device 700 to render immersive augmented reality or virtual reality.

The power supply 716 may include a hard-wired power supply, a battery power supply, or a combination thereof. The power supply 716 may provide power to the computing device 700 to allow the components of the computing device 700 to operate.

The presentation component(s) 718 may include a display (e.g., a monitor, a touch screen, a television screen, a heads-up-display (HUD), other display types, or a combination thereof), speakers, and/or other presentation components. The presentation component(s) 718 may receive data from other components (e.g., the GPU(s) 708, the CPU(s) 706, DPUs, etc.), and output the data (e.g., as an image, video, sound, etc.).

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “identifying,” “determining,” “storing,” “adjusting,” “causing,” “returning,” “comparing,” “creating,” “stopping,” “loading.” “copying,” “throwing,” “replacing,” “performing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Examples of the present disclosure also relate to an apparatus for performing the methods described herein. This apparatus can be specially constructed for the required purposes, or it can be a general purpose computer system selectively programmed by a computer program stored in the computer system. Such a computer program can be stored in a computer readable storage medium, such as, but not limited to, any type of disk including optical disks, CD-ROMs, and magnetic-optical disks, read-only memories (ROMs), random access memories (RAMs), EPROMs, EEPROMs, magnetic disk storage media, optical storage media, flash memory devices, other type of machine-accessible storage media, or any type of media suitable for storing electronic instructions, each coupled to a computer system bus.

The methods and displays presented herein are not inherently related to any particular computer or other apparatus. Various general purpose systems can be used with programs in accordance with the teachings herein, or it may prove convenient to construct a more specialized apparatus to perform the required method steps. The required structure for a variety of these systems will appear as set forth in the description below. In addition, the scope of the present disclosure is not limited to any particular programming language. It will be appreciated that a variety of programming languages can be used to implement the teachings of the present disclosure.

It is to be understood that the above description is intended to be illustrative, and not restrictive. Many other embodiment examples will be apparent to those of skill in the art upon reading and understanding the above description. Although the present disclosure describes specific examples, it will be recognized that the systems and methods of the present disclosure are not limited to the examples described herein, but can be practiced with modifications within the scope of the appended claims. Accordingly, the specification and drawings are to be regarded in an illustrative sense rather than a restrictive sense. The scope of the present disclosure should, therefore, be determined with reference to the appended claims, along with the full scope of equivalents to which such claims are entitled.

Other variations are within the spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors-for example, a non-transitory computer-readable storage medium store instructions and a main central processing computing device (“CPU”) executes some of instructions while a graphics processing computing device (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of the disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess network interface resource.

Although descriptions herein set forth example embodiments of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A computing system comprising:
a network interface card; and
a host device comprising a controller coupled to the network interface card, wherein the controller is configured to:
identify a command of an application of the host device to modify a network interface resource of the network interface card having a first hardware configuration;
cause the network interface card to determine a second hardware configuration that enables a modification to the network interface resource; and
responsive to a notification of the network interface card indicating that execution of at least a portion of the command to modify the network interface resource has not been completed, execute an incomplete portion of the command to modify the network interface resource.

2. The computing system of claim 1, wherein the network interface resource comprises one of a transport object or a network property.

3. The computing system of claim 1, wherein the transport object is one of a queue pair, a memory region, or a completion queue.

4. The computing system of claim 1, wherein the controller is further configured to:
identify a second command of the application of the host device to modify a second network interface resource of the network interface;
upon determining that the second network interface resource is not modifiable according to the second command, generate a third command to modify a third network interface resource as an alternative to the second network interface resource; and
forward the third command to the network interface card.

5. The computing system of claim 1, wherein to identify the command of the application, the controller is further configured to:
intercept the command of the application sent to the network interface card.

6. The computing system of claim 1, wherein to cause the network interface card to determine the second hardware configuration, the controller is further configured to:
determine an executable portion of the command to modify the network interface resource; and
provide the executable portion of the command to the network interface card for execution.

7. A method comprising:
determining, using a privileged host controller, one or more network interface resources of a network interface card hardware of a network interface card that are modifiable, wherein each of the one or more modifiable network interface resources of the network interface hardware is associated with one or more permissions;
identifying a command associated with a first user of a plurality of users to modify a first network interface resource of the one or more network interface resources of the network interface card hardware of the network interface card that are modifiable; and
upon determining, based on one or more permissions associated with the first network interface resource, that the first user is allowed to request modification of the first network interface resource, causing the network interface card to perform the command.

8. The method of claim 7, wherein the one or more network interface resources comprise one or more of transport objects or network properties.

9. The method of claim 8, wherein the transport objects are queue pairs, memory regions, or completion queues.

10. The method of claim 7, wherein each permission of the one or more permissions identifies a subset of the one or more network interface resources modifiable by a user of the plurality of users.

11. The method of claim 7, wherein determining the one or more network interface resources of the network interface card hardware of the network interface card that are modifiable further comprises:
accessing an instruction file stored within a memory storage on the network interface card to identify the one or more network interface resources that are modifiable.

12. The method of claim 11, wherein identifying the command associated with the first user of the plurality of users to modify the network interface resource of the network interface card further comprises:
determining that the first network interface resource is part of the one or more modifiable network interface resources identified based on the instruction file.

13. The method of claim 7, wherein causing the network interface card to perform the command further comprises:
forwarding the command to the network interface card;
receiving a notification of the network interface card indicating that execution of at least a portion of the command to modify the first network interface resource has not been completed;
executing, using the privileged host controller, an incomplete portion of the command to modify the first network interface resource; and
causing the privileged host controller to perform at least a portion of the command.

14. A method comprising:
identifying, using a privileged host controller of a host device, a command of an application of the host device to modify a network interface resource of a network interface card having a first hardware configuration;
causing, using the privileged host controller, the network interface card to determine a second hardware configuration that enables a modification to the network interface resource; and
responsive to a notification of the network interface card indicating that execution of at least a portion of the command to modify the network interface resource has not been completed, executing, using the privileged host controller, an incomplete portion of the command to modify the network interface resource.

15. The method of claim 14, wherein the network interface resource comprises one of a transport object or network property.

16. The method of claim 15, wherein the transport object is one of a queue pair, a memory region, or a completion queue.

17. The method of claim 14, further comprising:
identifying, using the privileged host controller, a second command of the application of the host device to modify a second network interface resource of the network interface;
upon determining that the second network interface resource is not modifiable according to the second command, generating a third command to modify a third network interface resource as an alternative to the second network interface resource; and
forwarding the third command to the network interface card.

18. The method of claim 14, wherein identifying, using the privileged host controller of the host device, the command of the application further comprises:
intercepting the command of the application sent to the network interface card.

19. The method of claim 14, wherein causing, using the privileged host controller, the network interface card to determine the second hardware configuration further comprises:
determining, using the privileged host controller, an executable portion of the command to modify the network interface resource; and
providing the executable portion of the command to the network interface card for execution.

20. The method of claim 14, wherein causing, using the privileged host controller, the network interface card to determine the second hardware configuration further comprises:
causing the network interface card to determine an executable portion of the command by providing the command to the network interface card for execution.
